(19) United States
(12) Patent Application Publication
(10) Pub. No.: US 2006/0099563 A1
(43) Pub. Date: May 11, 2006

(54) Computerized teaching, practice, and diagnosis system

(76) Inventors: Zhenyu Lawrence Liu, Pleasanton, CA (US); Xin Chen, Pleasanton, CA (US); Lang Shie Chen, Fremont, CA (US)

Correspondence Address: PATENT LAW OFFICES OF DAVID MILLERS, 6560 ASHFIELD COURT, SAN JOSE, CA, 95120, US

(21) Appl. No.: 10/982,439

(22) Filed: Nov. 5, 2004

(51) Int. Cl. G09B 3/00

(52) U.S. Cl. 434/350; 434/362

(57) ABSTRACT

A teaching system provides explanatory materials, examples, and problems on an interactive basis and adapts to the student. The system can generate random questions for presentation to the student as multi-step examples or practice problems. The student's answers during each step of a multi-step practice problem can be evaluated to identify weaknesses. Identified weaknesses can be remedied by presenting additional explanations, providing additional practice problems, and revisiting the weaknesses by inserting practice problems of the identified type into the student's subsequent lessons. The system can also adapt adjusting the speed or number of steps presented according to the student's performance. The system can further provide detailed analysis or diagnosis of the student's performance that can be communicated to teachers and/or parents for use in other teaching environments. The teaching system when embodied in a web site further provides communication among students, teachers, and parents.

### BACKGROUND

Economic realities generally limit the available resources that can be dedicated to education of children. Accordingly, educational tools are sought that can improve the efficiency of the teaching process. In particular, since the time available for teachers to interact with students either one-on-one or in classes is limited, teachers generally desire to employ the most efficient teaching systems and methods. Efficiency in teaching generally requires that the teachers appreciate which concepts are difficult for students and which concepts the students understand well. Testing can identify concepts that students have failed to master, but testing and thorough evaluations of tests can be time consuming.

One-on-one instruction is a particularly desirable teaching technique because the teacher gains real-time incite to the concepts that are giving a student difficulties, permitting the teacher to tailor instruction to the needs of that student. Unfortunately, extensive one-on-one instruction is economically impractical in most primary schools. Parents can play a significant role in one-on-one teaching of their children, but parents often lack teaching skills and also experience the difficulty of identifying the specific areas where their children may be having difficulties. Further, communication barriers often make it difficult for teachers and parents to co-ordinate teaching efforts and communicate regarding the specific areas where students are having difficulties.

Students can also teach themselves through self-study and homework, but homework and self-study generally do not give the student immediate feedback that could guide the student to use their time most efficiently. Additionally, students may not know where to begin when attempting to master new material or concepts they do not understand. Books and other printed materials generally only provide a fixed message that is unable to adapt to the students needs, so that the self-study using printed material may not be targeted at the right concepts.

Educational tools are thus needed that will aid teachers and parents in evaluating the strengths and weaknesses of their students to enable efficient targeted instruction. Tools are also desired that will give a student self-study options that automatically adapt to the needs of the student and give the student immediate feedback that can be shared with teachers and parents.

### SUMMARY

In accordance with an aspect of the invention, an automated or computer-aided teaching system enhances the traditional education by rapidly providing detailed analysis of a student's performance at the level of basic concepts and skills. The evaluation can be achieved using practice problems that are divided into multiple steps associated with basic concepts and skills, so that the teaching system allows students to give step-by-step answers when solving the practice problems. Analysis of the step-by-step answers identifies specific concepts and skills that the student has yet to master. Conventional education can then be targeted at the specific concepts and skills for the greatest benefit to the students. The teaching system can further use analysis of a student performance for automatic real-time selection of subsequent practice problems that are targeted to the student's needs. In accordance with another aspect of the invention, the teaching system can periodically provide refresher problems stressing concepts or skills that were historically difficult for the student.

In accordance with another aspect of the invention, a computer-aided teaching system includes a random problem generation system allows intensive drills of the targeted subject matter without repeating or exhausting the available problems. Real time diagnosis can precisely locate the errors and weaknesses and provide real-time teaching insertion through problem explanation and demonstration of problem solutions. The system can therefore adapt to the student's learning behavior and speed. When concepts and skills that are identified as difficult for a student, the system can automatically generate examples, practice problems, and fixed material targeted at those concepts and skills. The learning system can revisit the difficult concepts and skills at varied intervals during a learning session. The frequency of revisiting a concept or skill can change (e.g., decrease) as the student's answers to problems mark improvement or show that the student has achieved and maintained mastery of the concept.

In accordance with yet another aspect of the invention, computers executing a teaching system are networked to permit teachers to efficiently manage and monitor the students learning progress and analyze the results on a real-time basis for accurate adjustment of the next teaching step or strategy. The computer network can be linked within a campus or to off campus computers, for example, through the Internet. The teaching system when networked among teachers, parents, and students can provide efficient communications of detailed information regarding a student's studies at school or home. This interactive, bi-directional communications can improve the efficiency and quality of education.

One specific embodiment of the invention is an automated teaching process. The process begins with selecting a problem template from among a set of problem template, and randomly generating values for choices identified in the selected problem template. The random choices can be numbers, words, or identifiers for objects such as images that are part of a presentation of the problem. The process additionally presents a sequence of one or more questions that lead to a solution of the problem. The presentation of each question generally depends on the randomly generated values and may depend on the student's previous answers.

The student's answers to the questions can be compared to answers derived from the randomly generated values and formulas from the selected problem template. Diagnosis codes that correspond to the answers can identify performance values that are updated to reflect whether the answers from the student were correct. These performance values can indicate weaknesses and control whether the process provides additional teaching or review problems and the frequency of review or the speed of question presentation. In particular, the selected problem template can identify two or more sequence of questions leading to the solution with one sequence being shorter than the other, so that the process can select shorter or longer sequence of questions depending on the evaluation of the student's answers.

Another specific embodiment of the invention is an automated teaching process that includes: selecting a problem template from among a set of problem templates; randomly generating values for respective choices identified in the selected problem template; and receiving a selection of either a practice mode or an example mode. In response to the student selecting the practice mode, the process presents a sequence of one or more questions that depend on the randomly generated values and lead to a solution of the problem. In response to the student selecting the example mode, the process presents a sequence of one or more instructions that similarly depend on the randomly generated values and lead to the solution of the problem. The process can enable the student to switch between the practice mode and the example mode, for example, when the student is unsure on how to answer a question.

Another specific embodiment of the invention is a teaching system including a problem body table, a practice body table, an example body table, a practice presentation unit, and an example presentation unit. The problem body table contains entries corresponding to problems, and each entry identifies random choices and answers. The practice body table contains entries corresponding to the entries in the problem body table, and each entry in the practice body table includes information representing at least one sequence of questions leading to a solution of the problem associated with the corresponding entry in the problem body table. The example body table contains entries corresponding to the entries in the problem body table, and each entry in the example body table includes information representing a sequence of instructions leading to the solution of the problem associated with the corresponding entry in the problem body table. The practice presentation unit uses information from corresponding entries of the practice body table and the problem body table for presentation of the sequence of questions, and the example presentation unit uses information from corresponding entries of the example body table and the problem body table for presentation of the sequence of instructions.

Another specific embodiment of the invention is a teaching system that includes a practice problem presentation system, a user progress table, a diagnosis engine, and a management unit. The practice problem presentation system presents practice problems from a sequence of lessons. The diagnosis engine evaluates answers received from a student during presentation of the practice problems based and then updates the user progress table to indicate which of the lessons are complete. The management unit can access the user progress table and a schedule to determine whether the student is on schedule for progress through the lessons

Another specific embodiment of the invention is an automated teaching process that includes: setting a progress clock for completion of a sequence of lessons; presenting lessons to a user at a user controlled rate; comparing the user's progress through the lessons to the progress clock; and determining whether the user is ahead or behind schedule. Depending on whether the user is ahead or behind schedule, the process can then adjust teaching parameters such as the number of practice problems provided per lesson, the difficulty of practice problems, and the number or rate of review problems inserted into lessons.

Another specific embodiment of the invention is an automated teaching process including: presenting a current question from a sequence containing multiple questions leading to a solution for the problem; receiving an answer to the current question from a student; and repeating the presenting and receiving steps until the student has reached the solution. The student can control whether consecutive presentations of questions go on to a next question in an order of the sequence. The process can also include highlighting an area of a presentation of a question and presenting an explanation of how content of the area relates to answering the question. In addition or alternatively, the process can include: evaluating each answers to the questions in the sequence; locating diagnosis codes respectively corresponding to the answers; and updating progress categories corresponding to the diagnosis codes to reflect which of the answers where correct.

### BRIEF DESCRIPTION OF THE DRAWINGS

FIG. 1 shows flow diagram of an educational practice process in accordance with an embodiment of the invention.

FIG. 2 shows block diagram of a teaching system in accordance with an embodiment of the invention.

FIG. 3 is a block diagram of tables suitable for use in the teaching system of FIG. 2.

FIG. 4 is a flow diagram of a teaching process in accordance with an embodiment of the invention that reduces the number of presented steps during practice of a specific type of problem.

FIG. 5 is a flow diagram of a teaching process in accordance with an embodiment of the invention where the user selects the logical flow of a multi-step solution.

FIG. 6 is a block diagram illustrating the relationship of a teaching insertion unit and a diagnosis engine.

FIG. 7 is a block diagram illustrating an embodiment of the invention in which an interactive web site provides a learning system that is accessible to students, teachers, and parents.

Use of the same reference symbols in different figures indicates similar or identical items.

### DETAILED DESCRIPTION

A teaching system in accordance with an embodiment of the invention provides explanatory materials, examples, and problems on an interactive basis and adapts to the needs of a student. Additionally, the teaching system can provide detailed analysis or diagnosis of the student's performance that can be communicated to teachers and/or parents for use in other teaching environments.

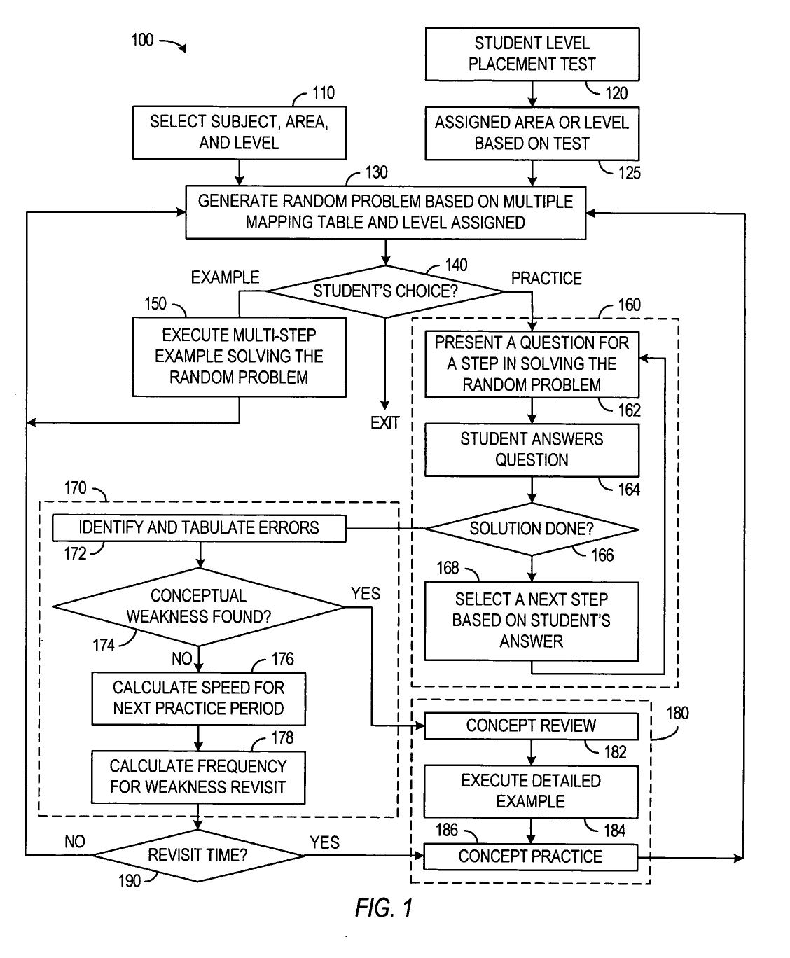

FIG. 1 is a flow diagram illustrating a teaching process 100 used by a student. Teaching process 100 is generally a computer-aided process in which either dedicated hardware or software implements portions of process 100 as described further below. Teaching process 100 is generally adaptable to teaching a variety of subjects at many different educational levels. In exemplary embodiment of the invention, teaching process 100 is directed to primary (K-12) education and the teaching of mathematics, science, or a similar subject in which the solving of problems may be divided into a multi-step logical process. Subjects such as mathematics and science are particularly suited for computer-aided learning because problems in these subjects are often numerically dependent and evaluated.

A subject matter and level is selected at the start of process 100. In one implementation of process 100, a person such as a teacher, a parent, or a student in step 110 simply selects a subject, area, and level for process 100. For example, a teacher may give a class assignment that identifies a particular lesson for students. Such lessons can be categorized using a standardized teaching curriculum that educational authorities commonly create. For example, lessons can be categorized using the academic standards of the California State Board of Education, as set forth for the CAT/6 standardized tests for the K-12 students. Each student then selects in step 110 the assigned subject, area, and level. Alternatively, the student may take a placement test in step 120 and an automated assignment in step 125 selects the subject, area, and/or level for the student using teaching process 100.

Step 130 generates a random problem based on the selected or assigned subject, area, and level. Selection of the random problem may further be based on the student's prior performance as described further below. In an exemplary embodiment of the invention, the generated problem is randomized first in selection from among problem templates in a class associated with the subject, area, and level of process 100. The selected problem template is further randomized through selection of items required for construction of a complete problem. The selections of items for a particular problem template may include, for example, numeric values that can be selected randomly from a target set or range so that numeric solutions or answers are seldom repeated. Further, items in the content, wording, graphics, or other presentation features associated with the template can be randomly selected from associated lists and provide variety in the random problems that will ideally help hold the students interest in solving practice problems.

Each problem template will generally be associated with a multi-step problem solving process. For example, the general problem of adding fractions may be associated with the steps of finding a common denominator from the fractions being added, multiplying the numerator and denominators of the fractions by appropriate factors, adding the resulting numerators of the fractions after multiplication, finding common factors in the numerator and denominator of the result, and simplifying the result accordingly. Associated with each step of a template are an instruction, a question, and one or more formulas for solution of that step. Each answer in that the student provides during the multi-step process may have a diagnosis code identifying a skill. For the example of adding fractions, the diagnosis codes may correspond to skills such as finding common denominators, multiplying numerator and denominator, simplifying fractions. The instructions associated with a template are generally for use when the teaching system presents the random problem as an example of problem solving technique. Process 100 uses the question associated with a step of the problem when the student is solving practice problems.

The student in step 140 chooses whether to see an example solution of a problem, attempt to solve a problem, or exit process 100. If the student chooses to see an example solution of the problem, step 150 presents a multi-step solution of the random problem. For each step of the problem, process 100 presents the instruction associated with the step as completed using the randomly selected items and numeric values. Teaching process 100 can thus lead the student step by step through the solution of the randomly generated problem.

Process 100 executes a practice routine 160 if the student in step 140 decides to practice solving problems. In the embodiment of FIG. 1, practice routine 160 includes presenting a student with a question associated with a current step of the random problem. The question will typically include the random numbers or items selected in step 130. The question may seek one or more numeric answers or may ask the student select from a number of choices on how to proceed logically in solving the problem posed. The student answers the question in step 164, before the teaching system in step 166 decides whether practice routine 160 is finished. If practice routine 160 for the current random problem is not complete, step 168 selects the next step associated with the problem. Selection of the next step may be based on the student's answer to the last question and/or the student's past performance on similar problems. For example, if the student answered the last question incorrectly, step 168 may ask the student to try again. If the student answered correctly and prior performance indicates the student has mastered the concept associated with the next question, step 168 may choose a question that combines two or more steps of the problem solution.

An evaluation routine 170 evaluates the student's performance and can be begun when practice routine 160 is complete or alternatively after each question. Evaluation routine 170 in step 172 identifies and tabulates the errors that the student made during practice routine 160. More specifically, the identified errors can be classified by the concept or concepts associated with the incorrect answer, and a table can record the number of right and wrong answers associated with each concept. Step 174 then determines whether a student's mastery of a particular concept is weak. A large number of errors associated with a particular concept or skill would indicate a weakness in the student's mastery of that concept or skill.

If step 174 detects a weakness, a review routine 180 for the detected weakness can be initiated. Review routine 180 may include a concept review step 182 in which the teaching system provides a description or explanation of the concept to the student. One or more solved examples that use the concept can then be presented in step 184, and targeted practice problems are given in step 186. Upon completion of review process 180, teaching process 100 can return to step 130 for generation of another random problem or return to evaluation routine 170 to complete further evaluation of the student's performance. The review process and routine 180 in general can be executed at anytime after a weakness is detected. In particular, routine 180 may be delayed while the students finishes a block of the problems, so that the student is provided with one of more review processes at the end of a lesson, a section, or a chapter.

If step 174 of evaluation routine 170 does not detect a particular weakness, step 176 calculates a speed for the practice problems of the evaluated type. For example, if a student masters the concepts or skills being presented by a specific type of practice problem, the number of practice problems using the mastered concepts or skills can be reduced. The practice problems can also be presented using fewer steps, and the calculated speed based on the student's mastery of the concepts or skills may control the number of steps used in the multi-step practice problems.

Step 178 calculates a frequency for revisiting previously identified weaknesses. In an exemplary embodiment of the invention, the frequency for the revisiting an identified weakness is proportional to the student's error rate for questions corresponding to the identified weakness. For example, if the error rate is 100% for problems corresponding to the weakness, the revisit frequency can be set at a highest level, e.g., a revisit index 9. If the error rate is 90%, the revisit frequency can be set somewhat lower, e.g., a revisit index 8. If error rate is below a target level (e.g., 10%), the revisit frequency can be set to zero. After each cycle of practice, e.g., each problem or lesson, the revisit index can be incremented, and a review process can be started when the revisit index reaches a target level, e.g., a revisit index 10.

Step 190, which in FIG. 1 is executed after evaluation routine 170, determines whether to revisit any of the concepts that have given the student particular difficulties. If step 190 determines it is time for a revisit, the next practice problem for the student will be a random problem that specifically uses the concept targeted for the revisit. The revisited practice problems can be the same type of problems identified and used in concept review routine 180. If step 190, determines it is not yet time to revisit any concepts, teaching process 100 branches back to step 130 to generate another random problem of the type that the student is currently studying.

Process 100 as described above can be implemented in hardware or software. Such software may be embodiment as machine-readable instructions in a storage medium such as a floppy disk, a CD ROM, a DVD ROM, or a memory stick to name a few. In one exemplary, embodiment process 100 is implemented in software for a standalone computer, one or more computers connected to a local area network, or computers interconnected through a wide area network or the Internet. For example, software that implements process 100 can be accessible and used through a web site.

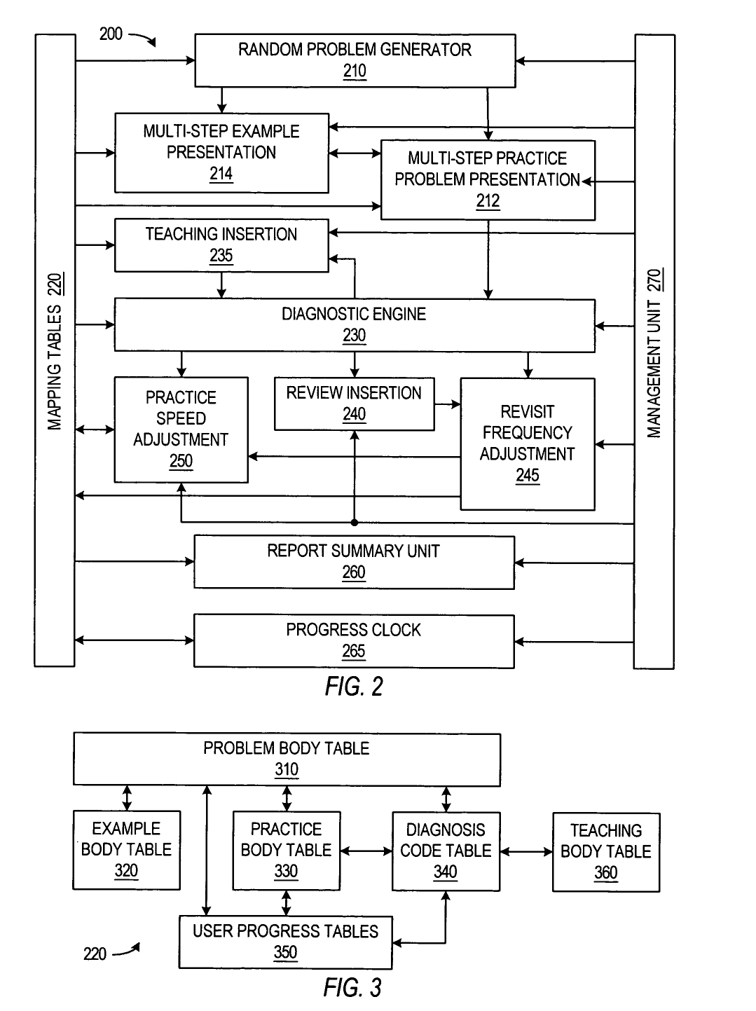

FIG. 2 illustrates the functional blocks of a system 200 for implementing a teaching process in accordance with an embodiment of the invention. System 200 includes a random problem generator 210, presentation units 212 and 214, mapping tables 220, a diagnostic engine 230, a teaching insertion unit 235, a review insertion unit 240, a revisit frequency adjustment unit 245, a practice speed adjustment unit 250, a report summary unit 260, a progress clock 265, and a management unit 270.

In the illustrated embodiment, random problem generator 210 uses mapping tables 220 to generate and present random problems for a specific grade, chapter, section, subject, lesson, or level. As shown in FIG. 3, mapping tables 220 can include a problem body table 310, an example body table 320, a practice body table 330, a diagnosis code table 340, user progress tables 350, and a teaching body table 360. Random problem generator 210 uses the student's level and/or the assigned lesson to generate a pointer that locates related entries in problem body table 310 and then selects one of the entries in problem body table 310. Each entry generally includes a label identifying information such as a grade, chapter, section, subject, lesson, level, example, variation, and type for the problem. The entry in problem body table 310 also includes code that identifies information that is common to both practice problems and example problems. In an exemplary embodiment of the invention, the code within each entry of problem body table 310 identifies a set of random choices rl to rn and a set of answers al to am, where n is the number of choices and m is the number of inputs required for generation and completion of a random problem.

Each entry in problem body table 310 generally has one or more corresponding entries in each of example body table 320 and practice body table 330. The entries in example body tables 320 provide information that is specific to presentation of an example problem, and the entries in practice body tables 330 provide information that is specific to presentation of a practice problem.

Equation 1 gives a general form for a procedure corresponding to a step, i.e., an instruction or a question that is part of a presentation of an example or practice problem. A single-step example or practice problem may only require one presentation P, but more generally an N-step example or practice problem may include N presentations PI to PN, with each being associated with a corresponding step. In Equation 1, presentation P represents the question or instruction body with a format F for the display, sound, or other media functions of presentation P. Random choices ri and answers ai are used with fixed content of a presentation at locations identified in format F. In particular, format F can indicate the locations of cells on a display screen, and the presentation can fill each cell with fixed content or an object that depends on a random choices ri or answers ai. Some examples of fixed content in the presentation may include fixed sentences, mathematical expressions, a set of available choices, pull down selections, multiple dimension geometric graphics, multiple dimension coordinates, still images, moving pictures, sound, and a mixture of these.
P=F(r1, r2, . . . , rn, a1, a2, . . . , am) Equation 1

Random choices rl to rn, which are generically referred to herein as choices ri, correspond to variables that may be displayed in the question or instruction body. Each choice ri can represent a number in any format, a set of one or more letters, one or more words, a multiple dimension geometric graphic, a set of coordinates, a still image, a moving image, or a sound. Random problem generator 210 can randomly select each choice ri from a number array, a table, or a call from a file depending on an identifying code for the choice ri. Some choices ri may alternatively be calculated from or dependent upon other choices ri. Choices ri are generally selected once for a problem and may be displayed in the presentations of multiple steps.

Answers al to am, which are generically referred to herein as answers ai, are inputs in practice mode and can be determined using formulas from tables 220 in example mode. Each answer ai would normally be received from the user when the random problem is used for practice but alternatively may be calculated from choices ri and associated formulas when the random problem is an example. Format F defines the locations of calculated answers ai in an instruction body or cues for the user's input in a question body. Depending on the context, answers ai can be numbers in any format, letters, words, multiple-choice selections, pull down selections, multiple dimension geometric drawing. In a practice problem, a presentation of a step may provide a text box, a menu, radio buttons, or similar graphic used as a marker or queue that is part of the interface for user assignment of the answer ai. The user can then input answers ai using a keyboard, a mouse button (or mouse movements on a coordinate system defined on the screen), a number or symbol picker, or a voice input. With a symbol picker, the system displays a pad containing items such as number or other symbols adjacent to the marker in response to the student moving a curser to the marker. The student can then use a mouse to select items on the pad and identify the answer being entered.

Multi-step practice problem presentation block 212 generally uses a question format F from practice body table 330 and choices ri from random problem generator 210 for presentation of each question associated with a practice problem. Similarly, multi-step example presentation block 214 can use instruction formats from example body table 320 for presentation of the instructions in one or more steps of an example problem.

User activation generally controls the multi-step presentation during presentation of an example or a practice problem. As indicated above, a presentation P may include multiple steps that a user activates upon completion of a previous step, and the next step in a presentation can very depending on user's selections or answers in previous steps. For example, if the user provides an answer ai in a prior step, the answer or values derived from the answer may be automatically displayed in presentations of following steps before the user provides additional input. The repeating or use of prior answers ai can make the connection between steps more natural and obvious to the user. In the general case, the user may is not limited to a specific method or order of steps for solving a problem, and the presentation may give the user a choice among more than one way of solving certain problems.

The multi-step presentation has several advantages over a single process where a user is simply presented with a problem and provides only the final answer. In particular, the multi-step presentation allows the user to focus on and learn each step needed to solve the problem. The multi-step logic also teaches a logical thought process for solving the problem. Further, multiple answers from the user permits diagnosis or analysis that can accurately locate the source of a user's error.

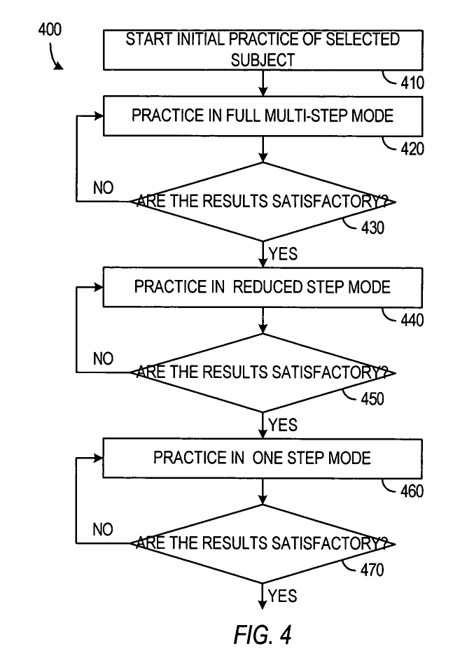

The multi-step operation of presentation units 212 and 214 of FIG. 2 can be modeled into presenting different combinations of steps depending on the practice results from the user. For example, FIG. 4 illustrates an example of a teaching process 400 were the number of steps presented for solving a specific type of practice problem changes according to the user's performance in solving problems having the same type code. In step 410, the user begins practice of a particular type or class of problems, a presentation step 420 presents a full set of steps/questions for the user to answer. A decision step 430 observes the user's answers to determine whether the user has reached a target level of mastery. If the user's performance suggests further practice with the full multi-step presentation, e.g., if the number of errors is above a target level, process 400 branches from step 430 back to step 420. If step 430 recognizes that the user has achieve the target level of mastery, step 440 provides a presentation version having a reduced number of steps, for example, in which some of the initially presented steps are combined. Combining steps in this manner tests whether the user can perform the combined steps without prompting. A decision step 450 determines whether the user has reached a level of mastery suitable for further reduction in the number of presented steps. Step 460 presents a practice problem using the smallest number of steps, e.g., a one-step presentation. Decision step 470 then leaves the user to practice at the speed providing the fewest steps to demonstrate the user's ability to solve the problem without prompting. Process 400 is complete when step 470 identifies that the user has reached the required level of mastery of that specific type of problem. Process 400 can then be used for problems of a new type.

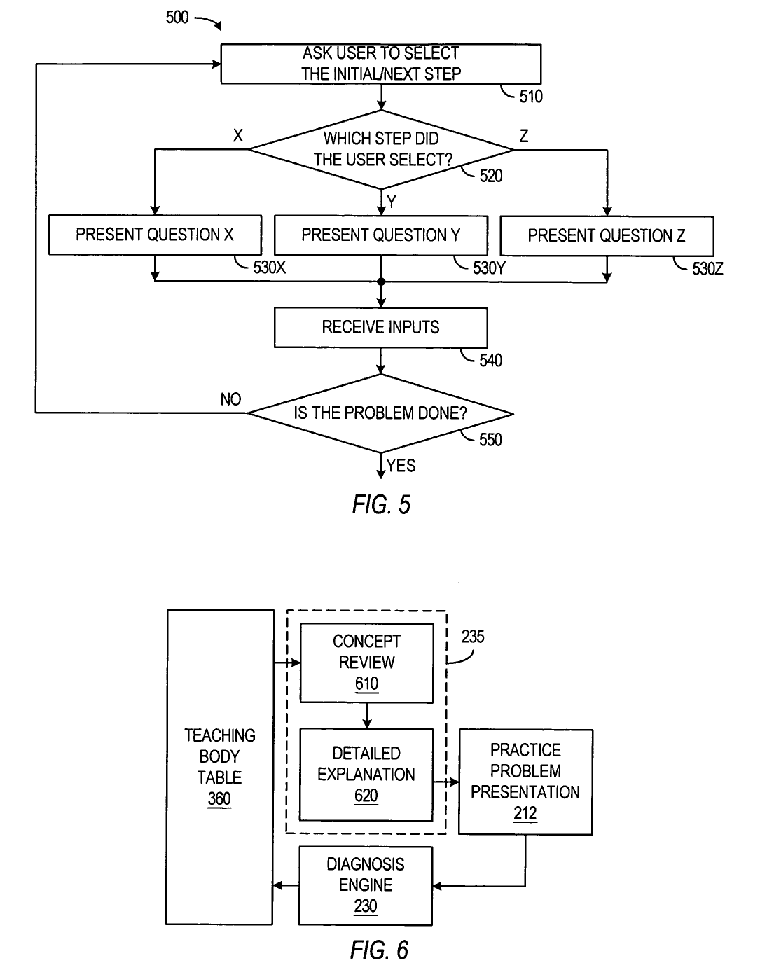

Practice problem generation unit 212 can also use the multi-step concept to track a user's preferred logical process for solving problems. FIG. 5, for example, illustrates a process 500 in which a user selects the steps for solving a practice problem. Process 500 begins with a step 510 presenting the user with options for an initial step in the solution of the problem. In FIG. 5, three possible selections are available, but more generally any number of alternatives may be provided depending on the problem. However, if only one selection is available, step 510 may be skipped. Decision step 520 then directs process 500 to a presentation 530X, 530Y, or 530Z of a question according to the user's selection, and the user in step 540 provides answers to the presented question. Decision step 550 then determines whether the solution of the problem is complete, and if not branches back to step 510. Each question presentation in step 510 will in general provide a different number of choices with the choices being dependent on the user's prior selections.

Another feature of teaching system 200 of FIG. 2 is the ability of the user to switch from a practice mode to an example mode. In particular, if the user unable to answer a question from practice problem presentation unit 212, the user can switch to example mode. Example presentation unit 214 can then present an instruction for the current step (or the example problem from its beginning) since both practice presentation unit 212 and example presentation unit 214 use the same random choices ri. The user can also be allowed to step backward in a multi-step example or practice problem if desired.

Practice presentation unit 212 or example presentation unit 214 can also provide an alternative help mode by displaying explanatory texts, graphs and/or voice that will explain the calculation, logic, or reasoning for a particular step or the relation of a particular choice ri or answer ai to the desired solution of the problem. The dynamic position corresponding to the feature of a presented question can be activated by highlighting or otherwise altering the appearance, for example, of certain choices ri and answers ai. In particular, the choices ri and answers ai that are the elements involved in explanatory texts, graphs, and/or voice can be similarly altered or highlighted, and the explanations can be displayed over or near the feature explained.

System 200 includes an architecture that has mapping tables 220 that can be linked to each other as shown in FIG. 3. In an exemplary embodiment of the invention, problem body table 310 contains executable code for generating portions of the problem that apply both to practice and example problems. The code in problem body table 310 can be linked and called out by random problem generator 210, for example, for or during selection of random choices ri or as part of the presentation of a problem. As noted above, each entry in problem body table 310 also identifies random choices ri and answers ai for a corresponding problem. The example body table 320 similarly contains code for the example body, and example presentation unit 214 can link to and called out the code from table 320. Each entry of example body table 320 includes a mapping or link to a corresponding entry of problem body table 310, and each entry of problem body table 310 includes a mapping or link back to a corresponding entry of example body table 320.

Practice body table 330 similarly contains the practice problem bodies that practice problem presentation unit 212 can call out for presentation of practice problems. Entries of example body table 330 include mappings or links to corresponding entries of problem body table 310 and/or example body table 320 and visa versa for use of information and/or executable code from tables 310 and 330 when system 200 operates in practice mode. With this architecture, entries from tables 310 and 320 can be called out bi-directionally for use of information or code from example body table 320 and/or practice body table 330, for example, when switching between a practice mode where practice problems are presented to an example mode where example problems are presented.

Diagnosis engine block 230 can access practice body table 330, diagnosis code tables 340, and user progress tables 350 when evaluating which answers ai are correct and tabulating the right and wrong answers in specific skill areas. Diagnosis code tables 340 are a group of tables contain diagnosis codes used by diagnosis engine 230. Each of the diagnosis code tables 340 is linked to a corresponding entry in problem body table 310 and therefore linked to a specific problem. The entries in each of the diagnosis code tables 340 correspond to the answers ai associated with the corresponding problem, and each entry is a diagnosis code that identifies a subject or skill associated with answer ai. When evaluating a user's response during a practice problem, diagnosis engine 340 as described further below identifies whether an answer ai is correct or incorrect, accesses an entry corresponding to the answer ai in the diagnosis code table associated with the evaluated problem, and tabulates the correct or incorrect answer in a corresponding entry of user progress table 350.

User progress tables 350 are used to indicate the user/progress status information such as: a current level, a current work on point, an overall grade, detail grades, an overall diagnosis result, detail diagnosis results, concepts or lessons needing review, problems that need revisiting, and speed up/speed down parameters. Generally, the status entries in tables 350 are linked to corresponding the entries in tables 310, 330, and 340.

Diagnosis engine 230 evaluates answers ai to practice problems to identify specific weaknesses in problem solving skills and/or overall weaknesses in completing a class of problems. In an exemplary embodiment of the invention, diagnosis engine 230 contains logic and equations that are linked with diagnosis code tables 340 for performing the diagnostic functions. Four primary diagnostic functions of diagnosis engine 230 are real time weakness detection, overall weaknesses analysis, detection of subjects to be revisited, and adjustment of the learning speed during practice problem presentations.

For real time weakness detection, diagnosis engine 230 activates error checking as soon as the user finished/answered the question or problem. The error checking compares the user's answers to calculated answers. The answers can be calculated using the random choices ri for the problem and the formulae from problem body table 310. Diagnosis code tables 340 can also assign each answer ai to a specific problem type and/or to a specific skill, and diagnosis engine 230 can then update user progress tables 350 to reflect correct and incorrect answers for the identified skills or problem types. In an exemplary embodiment, diagnosis engine 230 tabulates every answer ai as a right or wrong answer for the corresponding category or categories and for each incorrect answer gives the correct answer with example calculations or logical reasons for why or how the correct answer is found. Diagnosis engine 230 can also activate teaching insertion unit 235, which can then provide a fixed presentation to explain the concepts or techniques that diagnosis engine 230 identified as needing to be improved. Diagnosis engine 230 preferably presents the correct answers, the reasoning needed to arrive at the correct answer, and the list of the areas or skills requiring study on or near the user's error on a work sheet that practice presentation unit 212 provided.

When the user finishes a section of practice problems, for example corresponding to a lesson, unit, chapter, grade, . . . etc), diagnosis engine 230 performs an overall weaknesses analysis based on error accumulations in user progress tables 350. Such analysis can grade the overall correct/level percentage for this section of practice problems and grade each concept, technique, or skill used in the section of practices problems. As precursor to the overall grading or analysis, diagnosis engine 230 can calculate a percentage of right answers or a weighted average CRT for each diagnosis code ci as indicated in Equation 2. In Equation 2, n is the total number of evaluated practice problems having diagnosis code ci, j is an index identifying the particular practice problems, ARᵢⱼ is 1 if answer ai in problem j is correct and is 0 otherwise, and kj is a weight assigned to each problem j. Weights kj for calculation of the weighted average can be from a fixed table (not shown) and can generally have values that depend on the grade level and difficulty of problem j. The percentage of right answers or CRT can then be used in creating a list the concepts or techniques that may need further study after the completed practice section.

$$\begin{matrix}Equation 2 \text{:} & \\ {CRT}_{ci} = \frac{{\sum }_{j = 1}^{n} {k}_{j} {AR}_{ij}}{{\sum }_{j = 1}^{n} {k}_{j}} & \end{matrix}$$

A teaching insertion unit 235 can be called to present explanations of the identified concepts or skills having a low percentage of right answers. FIG. 6 illustrates the relationship of teaching insertion block 235 to diagnosis engine 230 and practice problem presentation unit 212 in an exemplary embodiment of the invention. As illustrated in FIG. 6, diagnosis engine 230 uses a diagnosis code corresponding to a question or skill to identify an entry in teaching body table 360. The identified entry, which corresponds to a diagnosis code identified for teaching insertion, can contain explanations of the concepts or skills corresponding to the diagnosis code and a detailed explanation of how to solve a corresponding problem. Teaching insertion unit 235 includes a routine 610 for presenting a review of the required concepts or skills and a routine 620 for presenting the detailed explanation of how to solve the problem. Teaching insertion unit 235 can provide a fixed detailed explanation in greater detail than does the example problems that example presentation unit 214 presents or alternatively may use a random example problem that example presentation unit 214 presents. Teaching insertion unit 235 can also activate practice problem presentation unit 212 to present a set of random problems corresponding to the identified diagnosis code. Diagnosis engine 230 can then evaluate this set of random problems to monitor the user's improvement.

Diagnosis engine 230 can also activate speed adjustment unit 250 to adjust the speeds for specific types of problems based on the overall error percentages. User progress tables 350 can also be updated as part of the overall evaluation of a section to show completion of the section and overall grades or evaluations of the section. Diagnosis engine 230 can thus make the overall grades/evaluations as well as the specific percentages of right/wrong answers for specific questions or skills available to report summary unit 260 for generation of reports for teachers, parents, or other users.

The practice revisit detection function of diagnosis engine 230 can also be initiated when the user finishes a section (e.g., a lesson, unit, chapter, or grade) of practices problems. The revisit detection generally includes an overall analysis based on the percentage of correct answers for a particular problem type. If the percentage of correct answers for a particular type of problem or skill is below the fixed or floating threshold, that type of problem or skill can be target for review and/or revisiting. Revisit frequency adjustment unit 245 can then set a frequency for revisiting the identified problem type or skill, so that review insertion unit 240 will be activated to present the user with targeted review problems. In an exemplary embodiment of the invention, revisit frequency adjustment unit 245 updates user progress table 350 to list each diagnosis code that diagnosis engine 230 identifies for a revisit and to provide a revisit frequency that can be calculated from the percentage of correct answers associated with the diagnosis code.

Review insertion unit 240 under direction of management unit 270 can start a revisit function that inserts a practice problem of the type or types that diagnostic engine 230 identified for revisiting. Each revisited problem is generally inserted among a current series of practice problems corresponding to a subsequent lesson, for example, when a student is practicing a lesson following the lesson in which a weakness was detected. For the revisit function, management unit 270 can set a progress break that allows review insertion unit 240 to perform the revisit function at the frequency set by revisit frequency adjustment block 245.

In an exemplary embodiment of the invention, revisit frequency adjustment block 245 determines a revisit frequency RFₘ for each diagnosis code m that diagnosis engine 230 identifies for revisiting. Equation 3 provides an example of a suitable formula for revisit frequency RFₘ. In Equation 3, CRVₘ is the weighted percentage of correct answers for diagnosis code m, T_{CRV} is threshold corresponding to a pass or fail level and is greater than weighted percentage CRVₘ since diagnosis code m is selected for revisiting, and sₘ is a proportional adaptive parameter for diagnosis code m. Parameter sₘ can be stored in a user progress table 350 and may depend on the student's over performance, the grade level, the problem difficulty, and the error importance. Parameter sₘ can thus scale the revisit frequency depending on the significance of the diagnosis code m. For example, parameter sₘ for a problem type m that is relatively unimportant for the student's current grade level may be small to reduce the revisit frequency for the less important problems.
RFₘ=sₘ(T_{CRV}−CRVₘ) Equation 3

Diagnosis engine 230 also provides the needed input for learning speed adjustment. The learning speed adjustment can be based on the student's recent performance in completing problems. For this purpose, diagnosis engine 230 can run on the overall analysis to get weighted percentage CRV_{ci} of correct answers for diagnosis code ci during the most recent practice session. Equation 4 gives a suitable formula for weighted percentage CRV. In Equation 4, np is the total number of evaluated practice problems with diagnosis code ci in the last practice section, j is an index identifying the particular practice problems, PRᵢⱼ is 1 if answer ai in problem j is correct and is 0 otherwise, and qⱼ is a weight assigned to each problem j. Weightings qⱼ may be the same as weightings kⱼ or alternatively may differ to provide an overall evaluation specific to the current section. If the weighted average CRV_{ci} of correct answers is above a fixed or variable threshold, the practice speed for the type of problem corresponding to diagnosis code ci can be increased.

$$\begin{matrix}Equation 4 \text{:} & \\ {CRV}_{ci} = \frac{{\sum }_{j = 1}^{np} {q}_{j} {PR}_{ij}}{{\sum }_{j = 1}^{np} {q}_{j}} & \end{matrix}$$

In an exemplary embodiment of the invention, the practice speed is set for all problems in the next session of practice according to an average of the percentage of correct answers for practice problems in the last practice session. Equation 5 gives a formula for a learning speed parameter LSP the weight percentage CRVₘ correct answers, the number nd of diagnosis codes associated with the last practice session, and weighting factors wₘ for the diagnosis codes. Weighting factors wₘ can indicate an importance factor for each diagnosis codes. For example, if a diagnosis code i corresponds to important subject matter, then weighting factor wᵢ can be set to 1, otherwise weighting factor wᵢ could be less than 1. Practice problem presentation unit 212 can use the learning speed parameter LSP to select the number of step presented for a practice problem.

$$\begin{matrix}Equation 5 \text{:} & \\ LSP = \frac{{\sum }_{j = 1}^{nd} {w}_{j} {CRV}_{j}}{{\sum }_{j = 1}^{nd} {w}_{j}} & \end{matrix}$$

Progress clock 265 in an exemplary embodiment of the invention controls or selects the main lessons that system 200 of FIG. 2 presents. Unless the user directly selects particular subject matter, system 200 can present lessons sequentially in a linear or non- linear manner as desired for completion of series of lessons within a selected time span. Additionally, as noted above, revisited problems can be inserted into the series of lessons to review concepts that were originally more difficult for the student. The time span for a series of lessons could be a calendar or school year, semester, a quarter, a month, or any desired time period set for learning the subject matter contained in the series of lessons. Typically, progress clock 265 will be synchronized to the present calendar time movement.

One purpose of progress clock 265 can be for comparison of the student's progress as noted in user progress tables 350 to a schedule for completing the lessons in the allotted time. Progress clock can also provide a time parameter to management unit 270. Management unit 270 can then perform functions such as sending a warning signal to the user stating his/her progress is behind the schedule and then intensify the learning/practice efforts to let the user catch up. Alternatively, management unit 270 can send a congratulation signal to the user indicating that the student's progress is ahead of schedule. Central management unit 270 or the user can then choose to do more difficult practice problems, do extra learning/practice for any previously detected weaknesses, or make up some learning/practice/subject which was skipped, for example, due to a late sign-up for use of system 200.

Management unit 270 more generally has interfaces to all of the other units in system 200 and can generally control operation of system 200, for example, to implement the teaching process of FIG. 1.

Much of the above concentrated on the teaching functions of system 200 and emphasized operation where the user is the student. System 200 can also be used as an evaluation tool reporting the student's progress to teachers or parents. Report summary unit 260 processes the data stored in user progress tables 350 to generate reports. Such reports can be provided in a variety of formats such as raw data, a table, or a graph and may include a user-selected combination of information about the student's progress. Some of the information about a student's progress that may be included in a report includes: the student's current level, the current lesson, overall performance, detail performance categorized by any or all of the subjects having diagnosis codes, related performance indicating the student's strengths and needs, overall diagnosis result listing the student's overall weaknesses, detail diagnosis result listing specifics or details regarding the weaknesses, concept or lessons that the student needs to review, questions/problems that need revisiting, the speed up/speed down parameter, the student's overall or detailed progress in comparison to the master calendar, the time efficiency of the student's overall progress, and the students' time efficiency for recent progress. Such reports can be printed or transmitted electronically via a network such as a local area network (LAN) or a wide area network such as the Internet to a computer used by a teacher.

The teaching system and process described above can be implemented and used in a variety of environments or situations. For example, in one embodiment, teaching system 200 is implemented on a standalone computer that the student uses for at home or at school.

A group of students working on separate computers at a central location such as a school or at separate locations can use copies of system 200 as described above. An advantage of the random problem generation described above is that each student in a class can be provided with different problems (e.g., with different numeric answers) that teach the same subject. This makes cheating or sharing of answers more difficult and does not increase the difficulty of grading or evaluating the students' answers. A teacher with access to the network can monitor the performance and progress of all of the students and quickly have student evaluations that would take a great deal of time to generate by hand.

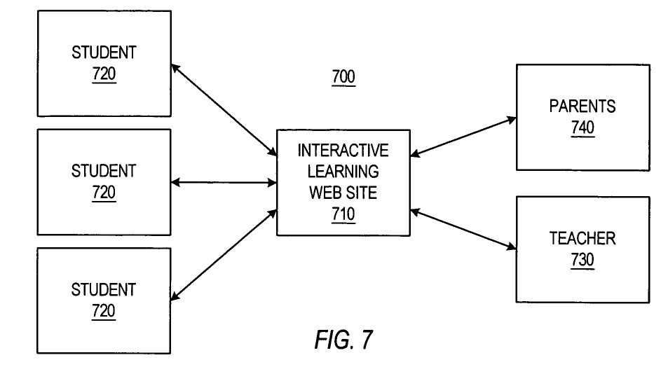

FIG. 7 illustrates an exemplary embodiment of a learning system 700 in which a web site 710 provides a teaching process or system similar to those described above in regard to FIGS. 1 and 2. Students 720 use web site 700 by logging in and viewing examples or solving practice problems. A teacher 730 can similarly log on to web site 700 to communicate with students 710 and/or parents 740, to assign lessons to students 710, or to access reports on any of the students 710 that web site 710 identifies as being in the class of teacher 730. Parents or guardians 740 can also log on to web site 710 and have access to information from teacher 730 or reports on the performance or needs of their child 710.

Although the invention has been described with reference to particular embodiments, the description is only an example of the invention's application and should not be taken as a limitation. Various adaptations and combinations of features of the embodiments disclosed are within the scope of the invention as defined by the following claims.

What is claimed is:

1. An automated teaching process comprising:
selecting a problem template from among a set of problem templates;
randomly generating values for respective choices identified in the selected problem template;
presenting a sequence of one or more questions to a student, wherein the question presented depends on the randomly generated values;
receiving answers from the student; and
comparing the answers from the student to answers derived from the randomly generated values and formulas from the selected problem template.

2. The process of claim 1, wherein at least one of the random values is a numeric value.

3. The process of claim 1, wherein at least one of the random values identifies an image to be displayed when presenting the question.

4. The process of claim 1, wherein the selected template identifies locations for presentation of the randomly selected values in the question.

5. The process of claim 1, wherein the selected template provides locations for a plurality of cells, wherein items identified by the randomly generated values are located in respective cells when presenting a question.

6. The process of claim 1, further comprising presenting a sequence of questions that the selected problem template identifies as leading to a final solution.

7. The process of claim 6, wherein content of presentation of one of the sequence of question contains content that depends on one or more of the answers from the student.

8. The process of claim 1, wherein receiving answers from the student comprises:
displaying a marker indicating a location for an answer;
displaying a pad in adjacent to the marker in response to the student moving a curser to the marker; and
identifying the answer based on the student selecting items on the pad.

9. The process of claim 1, wherein the selected problem template identifies a first sequence of questions leading to a final solution and a second sequence of questions leading to the final solution, the second sequence including fewer questions that are in the first sequence, wherein the process further comprises evaluating answers the student gave for prior problems to determine whether to present the first or second sequence of questions.

10. The process of claim 1, further comprising:
identifying a diagnosis code that corresponds to at least one of the answers from the student; and
updating a performance value corresponding to the diagnosis code to reflect whether the answer from the student was correct.

11. The process of claim 10, further comprising:
using the performance value to determine whether review of a concept associated with the diagnosis code requires review; and
presenting an explanation of the concept associated with the diagnosis code.

12. The process of claim 10, further comprising:
using the performance value to determine whether a concept associated with the diagnosis code should be revisited; and
inserting a practice problem corresponding to the diagnosis code among a subsequent series of practice problems addressing concepts other than the concept associated with the diagnosis code.

13. The process of claim 12, further comprising using the performance value to determine a frequency for inserting practice problems corresponding to the diagnosis code among the subsequent series of practice problems.

14. The process of claim 10, further comprising using the performance value to determine a speed for presentation of subsequent practice problems.

15. An automated teaching process comprising:
selecting a problem template from among a set of problem templates;
randomly generating values for respective choices identified in the selected problem template;
receiving a selection of either a first mode or a second mode;
in response to the student selecting the first mode, presenting a sequence of one or more questions, wherein the questions presented depend on the randomly generated values and lead to a final solution; and
in response to the student selecting the second mode, presenting a sequence of one or more instructions, wherein the instructions presented depend on the randomly generated values and lead to the final solution.

16. The process of claim 15, wherein receiving the selection of the second mode occurs after presentation of at least one question from the sequence of one or more questions, and wherein presenting the sequence of one or more instructions comprises presenting an instruction that indicates how to answer a corresponding one of the presented questions.

17. The process of claim 15, further comprising switching between stepping forward through the sequence being presented and stepping backward through the sequence being presented in response to a user command.

18. A teaching system comprising:
a problem body table containing a plurality of entries, each entry corresponding to a problem and identifying a set of random choices and a set of answers;
a practice body table containing a plurality of entries, each entry of the practice body table corresponding to one of the entries in the problem body table and including information representing a sequence of questions leading to a solution of the problem associated with the corresponding entry in the problem body table;
an example body table containing a plurality of entries, each entry of the example body table corresponding to one of the entries in the problem body table and including information representing a sequence of instructions leading to the solution of the problem associated with the corresponding entry in the problem body table;
a practice presentation unit that uses information from corresponding entries of the practice body table and the problem body table for presentation of the sequence of questions; and
an example presentation unit that uses information from corresponding entries of the example body table and the problem body table for presentation of the sequence of instructions.

19. A teaching system comprising:
a practice problem presentation system that presents practice problems from a sequence of lessons;
a user progress table;
a diagnosis engine that evaluates answers received from a student during presentation of the practice problems based, the diagnosis engine updating the user progress table to indicate which of the lessons are complete; and
a management unit capable of accessing the user progress table and a schedule to determine whether the student is on schedule for progress through the lessons

20. An automated teaching process comprising:
setting a progress clock for completion of a sequence of lessons;
presenting lessons to a user at a user controlled rate;
comparing user progress through the lessons to the progress clock; and
determining whether the user is ahead or behind schedule.

21. The process of claim 20, further comprising adjusting a number of practice problems provided per lesson according to whether the user is ahead or behind schedule.

22. The process of claim 20, further comprising adjusting the difficulty of practice problems according to whether the user is ahead or behind schedule.

23. The process of claim 20, further comprising inserting review problems into lessons at a rate that depends whether the user is ahead or behind schedule.

24. An automated teaching process comprising:
selecting a problem;
presenting a current question from a sequence to a student, wherein the sequence contains multiple questions leading to a solution for the problem;
receiving an answer to the current question from the student; and
repeating the presenting and receiving steps until the student has reached the solution.

25. The process of claim 24, wherein the student controls whether consecutive repetitions of presenting the questions go on to a next question in an order of the sequence.

26. The process of claim 24, comprising:
highlighting an area of a presentation of a question; and
presenting an explanation of how contents of the area relates to answering the question.

27. The process of claim 24, further comprising:
evaluating each answers to the questions in the sequence;
locating diagnosis codes respectively corresponding to the answers; and
updating progress categories corresponding to the diagnosis codes to reflect which of the answers where correct.
